(19) United States
(12) Patent Application Publication
(10) Pub. No.: US 2006/0137713 A1
(43) Pub. Date: Jun. 29, 2006

(54) Apparatus for cleaning wafer and method of pre-cleaning wafer for gate oxide formation

(75) Inventor: Wan Shick Kim, Yongin-si (KR)

Correspondence Address: THE LAW OFFICES OF ANDREW D. FORTNEY, PH.D., P.C., 7257 N. MAPLE AVENUE, BLDG. D, SUITE 107, FRESNO, CA, 93720, US

(73) Assignee: DongbuAnam Semiconductor Inc.

(21) Appl. No.: 11/293,618

(22) Filed: Dec. 2, 2005

(30) Foreign Application Priority Data
Dec. 29, 2004 (KR) 10-2004-0115805

(51) Int. Cl. C23G 1/00; B08B 3/00; B08B 7/00

(52) U.S. Cl. 134/2; 134/94.1; 134/157; 134/33; 134/137; 134/26

(57) ABSTRACT

An apparatus and a method for cleaning a wafer are described. A wafer is inserted into a bath by a loader, is supported by a guide in the bath, and is rotated by a roller. A cleaning solution such as dilute HF may remove impurities from the wafer by an etching operation, and then DI water is used to rinse the wafer. Since the wafer rotates by the roller, etching may be relatively uniform. Moreover, the rotation of the wafer during the rinse step can prevent or reduce the incidence of impurities combining with silicon dangling bonds on the wafer. Therefore, the apparatus and the method of the invention can effectively reduce or prevent defects on the wafer, regardless of loading configuration of the wafers.

### CROSS REFERENCE TO RELATED APPLICATIONS

This U.S. non-provisional application claims priority under 35 U.S.C. §119 from Korean Patent Application No. 2004-115805, which was filed in the Korean Intellectual Property Office on Dec. 29, 2004, the contents of which are incorporated by reference herein in its entirety.

### BACKGROUND OF THE INVENTION

1. Field of the Invention

The present invention relates generally to wafer cleaning technology and, more particularly, to an apparatus for cleaning a wafer and a method of pre-cleaning the wafer for gate oxide formation.

2. Description of the Related Art

In the last several decades, semiconductor device technologies have been improving at a dramatic rate along with an amazing increase in the complexity of integrated circuits and a remarkable growth of related process techniques. Some improvements in transistors are due to reductions in channel length and gate oxide thickness. Wet cleaning, a frequently repeated step in wafer fabrication, is a critical step in forming a thin gate oxide.

The main purpose of the cleaning process is to reduce a variety of contaminants to a minimum before and/or after certain steps of wafer fabrication. In general, contaminants on the wafer surface may include particles, organics, metals, and native oxides. Especially, particles may cause unwanted defects in equipment and/or on wafers and a drop in yield. In addition, metallic contaminants may lead to a degradation in gate oxide integrity, an increase in leakage current, a reduction in retention time, and so forth. In order to remove such contaminants, cleaning solutions (or mixtures thereof) for each contaminant (or each type of contaminant) have been used in the wet cleaning process. The ideal aim of the cleaning process is to remove all of the contaminants from the wafer surface. This may, however, be very difficult to accomplish in fact.

One of the conventional cleaning techniques is disclosed in the Korean Patent Publication No. 2004-69452. According to this disclosure, a method and an apparatus for cleaning a substrate are provided to clean effectively a wafer by performing selectively a dipping/cleaning process, a liquid injection/cleaning process, and a gas injection/cleaning process within a single process chamber.

Such conventional cleaning techniques may, however, require a very complicated process. Moreover, impurities separated from wafer surfaces by a cleaning solution (e.g., dilute HF) may act as potential contaminants in a cleaning bath, and further, may cause unfavorable defects on the front surface of the wafer. Specifically, impurities separated from the wafer surfaces may be often combined with dangling bonds (e.g., from silicon atoms) on the front surface of another (e.g., the adjacent) wafer. These combined impurities may act as an obstacle to the growth of an oxide film when, during a subsequent ozone treatment, the oxide film grows by combining oxygen-containing species with dangling bonds of silicon that have not combined with impurities. Thus it is possible that no oxide film forms in locations where the impurities exist (e.g., as may be combined with dangling silicon bonds). Unfortunately, this may cause a non-uniform oxide film and resultant defects on the wafer. Such issues may be critical in the case of a front-to-back loading configuration of the wafers during oxidation of a plurality (e.g., a batch or lot) of wafers.

### SUMMARY OF THE INVENTION

Exemplary, non-limiting embodiments of the present invention provide an apparatus for cleaning a wafer and a method of pre-cleaning the wafer for gate oxide formation so as to prevent defects on the wafer, regardless of the loading configuration of the wafers.

According to one exemplary embodiment of the present invention, the apparatus comprises a cleaning bath in which a cleaning process is performed, and a loader by which the wafer is loaded into the bath. The apparatus further comprises a guide in the bath and configured to rotatably support the wafer, a roller turning round to drive the wafer, one or more solution supply lines through which various solutions are supplied into the bath, and a solution drain line through which the solutions are removed from the bath.

In the apparatus, the loader may be configured to use either a front-to-back wafer loading configuration or a front-to-front wafer loading configuration. The roller may be formed on the loader. The guide may be configured to support a number of wafers at the same time, thus allowing a batch process.

According to another exemplary embodiment of the present invention, the method comprises loading at least one wafer into a cleaning bath, rotating the wafer in the bath, removing impurities from a back surface of the wafer by using a cleaning solution, rinsing the wafer by using DI water, and stopping the rotation of the wafer.

In the method, the loading of the wafer may include loading the wafer on a loader, inserting the wafer into the bath by the loader, and supporting the wafer to a guide. The loader may use either a front-to-back wafer loading configuration or a front-to-front wafer loading configuration. The guide may support a number of wafers. Rotating the wafer may comprise turning or rotating a roller around to drive the wafer. The roller may rotate a number of wafers in different directions. And, the cleaning solution may include dilute HF. The method may further comprise treating the wafer with HCl and ozone after the stopping of the wafer. Additionally, the method may further comprise drying the wafer after the treating of the wafer.

### BRIEF DESCRIPTION OF THE DRAWINGS

FIG. 1 schematically shows a front-to-back loading configuration of wafers used in a wafer cleaning method.

FIG. 2 schematically shows a front-to-front loading configuration of wafers used in a wafer cleaning method.

FIG. 3 schematically shows a general mechanism of impurity transformation in a wafer pre-cleaning method for gate oxide formation.

FIG. 4 schematically shows defects on a wafer caused by impurity transformation.

FIG. 5 schematically shows an apparatus for cleaning a wafer in accordance with an exemplary embodiment of the present invention.

### DETAILED DESCRIPTION OF EXEMPLARY EMBODIMENTS OF THE INVENTION

One or more exemplary, non-limiting embodiments of the present invention will now be described more fully hereinafter with reference to the accompanying drawings. This invention may, however, be embodied in many different forms and should not be construed as limited to the exemplary embodiment(s) set forth herein. Rather, the disclosed embodiment(s) are provided so that this disclosure may more fully convey the scope and/or implementation of the invention to those skilled in the art. The principles and features of this invention may be employed in varied and numerous embodiments without departing from the scope of the invention.

It is noted that well-known structures and processes are not described or illustrated in detail to avoid obscuring the essence of the present invention. It is also noted that the figures may not be drawn to scale. Rather, for simplicity and clarity of illustration, the dimensions of some of the elements may be exaggerated relative to other elements.

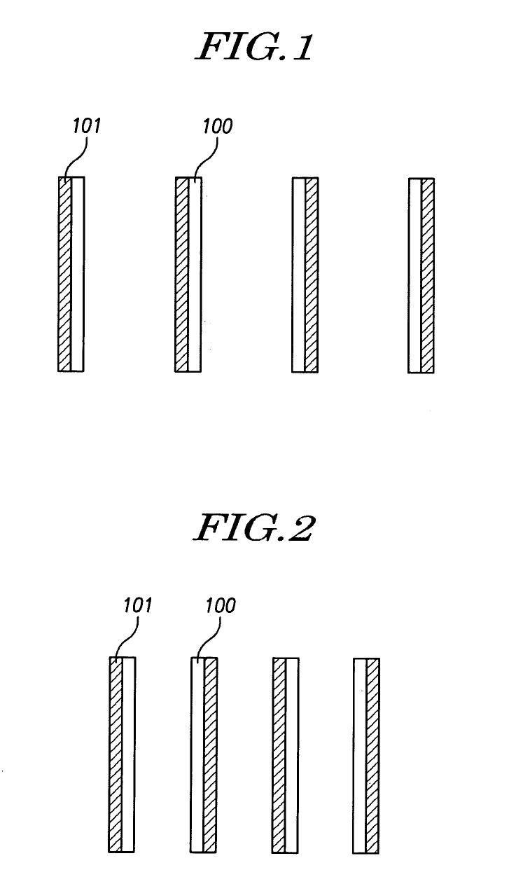

FIGS. 1 and 2 show respectively, in schematic views, a front-to-back loading configuration and a front-to-front loading configuration that are typically used in a wafer pre-cleaning (or cleaning) method. As shown in FIG. 1, the front-to-back loading configuration arranges two wafers of the group of wafers being pre-cleaned so that their front surfaces 100 may face each other. The other wafers in the group are arranged so that their front surfaces 100 may face the back surfaces 101 of adjacent wafers. The front-to-front loading configuration, shown in FIG. 2, arranges all the wafers so that their front surface 100 may face another front surface 100 (i.e., the front surface of one wafer faces the front surface of an adjacent wafer, or pairs of wafers are arranged so that they face each other.)

In general, impurities removed from surfaces of the wafer by a cleaning solution (e.g., dilute HF) may be harmless products. However, in most cases, such impurities still remain in the cleaning solution, and as pre-cleaning progresses, the concentration of the impurities may continuously increase. Increased impurities may act as potential contaminants in a cleaning bath. On the other hand, as the impurity removal on the wafer surfaces advances, the concentration of reacting substance in the cleaning solution gradually decreases. Furthermore, decreasing concentration of the reacting substance reduces the impurity removal reaction rate.

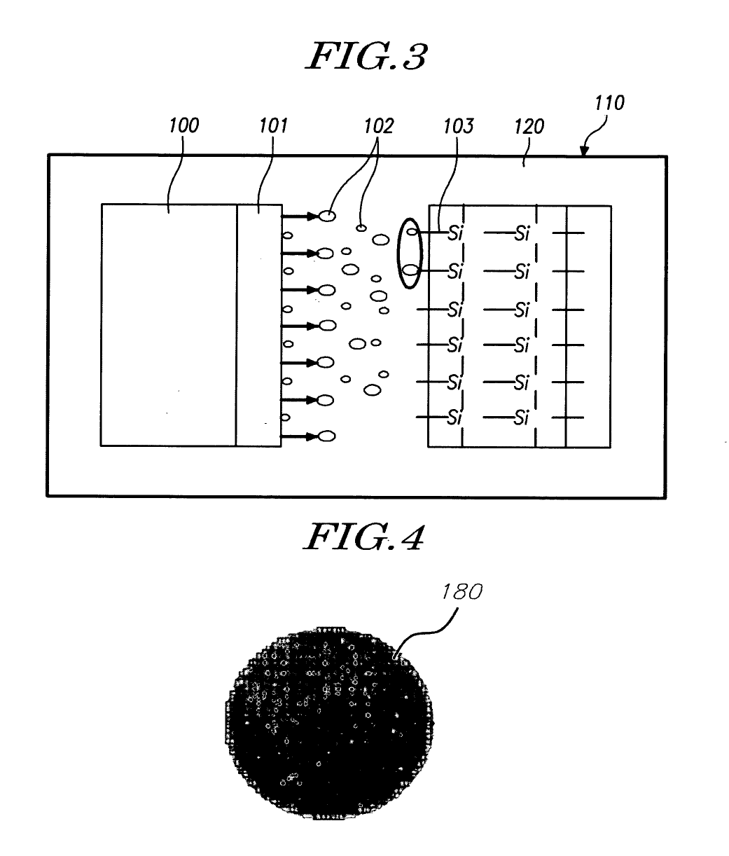

FIG. 3 shows a general mechanism of impurity transformation in a method of cleaning a wafer for subsequent gate oxide formation. (The term “pre-cleaning” generally refers to a cleaning process performed before a subsequent manufacturing process, such as gate oxide formation.) In general, such impurity transformation may occur chiefly during a DI water rinse step, performed after a cleaning step using dilute HF. Although cleaning with dilute HF is a preferred embodiment, the invention may use any conventional or generally-recognized agent or solution for cleaning wafers, particularly those having exposed silicon surfaces.

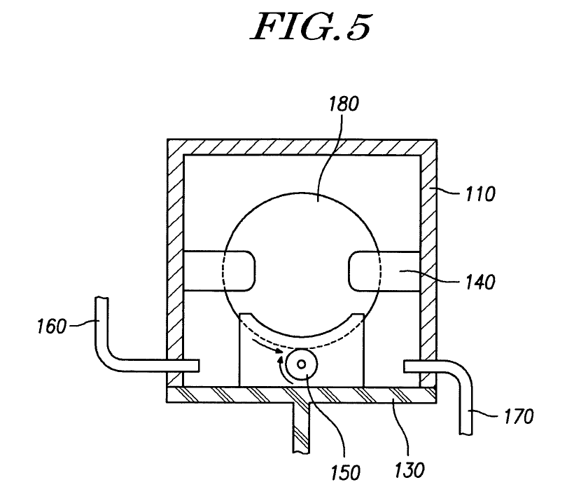

Referring to FIG. 3, two wafers are arranged in the front-to-back loading configuration in a cleaning bath 110. DI water 120 is supplied into the bath 110 from a lower part of the bath 110. The impurities 102 removed from the back surface 101 of a first wafer may combine with silicon having dangling bonds 103 on the front surface 100 of the adjacent wafer. These combined impurities may not be completely removed by a subsequent cleaning using HCl. Further, the impurities bound to the front surface of a wafer may act as an obstacle to the growth of an oxide film during a subsequent ozone treatment. Unfortunately, this may cause a non-uniform oxide film and resultant defects on the wafer. FIG. 4 is a two-dimensional wafer map, showing such defects on a wafer 180 caused by impurity transformation.

FIG. 5 is a cross-sectional view of an apparatus for cleaning a wafer in accordance with an exemplary embodiment of the present invention. Referring to FIG. 5, the cleaning apparatus includes a cleaning bath 110 in which the cleaning process may be performed, and a loader 130 by which one or more wafers 180 (preferably a plurality of such wafers) are loaded into the bath 110. The apparatus further includes a guide 140 (that may comprise a plurality of guide sections mounted or attached to different and/or opposed walls of the apparatus) in the bath 110 and configured to support the wafer(s) 180, and a roller 150 that may be on the loader 130 and that is configured to turn rotatably to drive the wafer(s) 180 supported by the guide 140. Alternatively, the roller (or other rotatable wafer drive mechanism) may be located on a wall of the bath or in a guide section, etc. Additionally, the apparatus includes one or more solution supply lines 160 through which various solutions such as dilute HF, HCl, ozone, and DI water are supplied into the bath 110, and a solution drain line 170 through which such solutions are removed from the bath 110.

Although favorably using the front-to-back loading configuration, the loader 130 may alternatively use the front-to-front loading configuration for arranging the wafers 180. The guide 140 can support a plurality of wafers 180 at the same time, thus allowing a batch process. For example, from forty five to fifty five wafers may be supported by the guide 140. The roller 150 can be positioned at any location in the bath, provided that it drives the wafers 180. It is, however, desirable that the roller 150 is located on the loader 130 or bottom surface of the bath, under the wafers, so that gravitational force can assist or enable continuous contact between the roller and the circumference of the wafer(s).

In the method of pre-cleaning the wafer prior to gate oxide formation, at least one, and preferably plural, wafer(s) 180 are loaded on the loader 130. The wafer 180 is inserted into the bath 110 by the action of the loader 130 (or, alternatively, a bath cover 110 may be lowered onto the loader 130), and then the wafers are supported by the guide 140.

Thereafter, while the roller 150 turns round (e.g., rotates) to drive the wafer(s) 180, dilute HF is supplied into the bath 110 through the supply line 160. The dilute HF is believed to remove impurities from the back surface of the wafer 180 by (mild) etching. Since the wafer(s) 180 are rotated by the roller 150, such backside etching may be substantially uniform.

On the other hand, the guide 140 may be configured to support a plurality of wafers 180. In this case, the wafers 180 may rotate in different directions. In such a configuration, the roller may advantageously comprises a plurality of roller sections, in which alternating roller sections may be configured to rotate the wafer[s] in contact therewith in different directions, in accordance with techniques known to those skilled in the art. After the impurity removing step, the dilute HF may be drained away through the drain line 170.

Next, the wafer(s) 180 undergo a rinse step in which the wafer(s) 180 are rinsed using DI water. In this step, DI water is supplied into the bath 110 through the supply line 160, and the wafer(s) 180 still rotate. The rotation of the wafer(s) 180 during the rinse step may prevent or reduce the incidence of the impurities combining with silicon having dangling bonds. After the rinse step, DI water (along with any residual impurities and dilute HF or other cleaning agent) may be drained away through the drain line 170.

Next, the wafer(s) 180 stop rotating by stopping the rotation of the roller 150. Then the wafer(s) 180 may be treated with HCl and ozone, and finally dried, prior to transfer to an apparatus for growing a gate oxide (or, in the case of forming a shallow trench isolation [STI] structure, growing a buffer oxide in the trench).

As discussed hereinbefore, the apparatus and the method according to the present invention allows the rotation of the wafers while cleaning and rinsing steps are performed. Therefore, the apparatus and the method of the invention can effectively prevent or reduce the incidence of defects on the wafer, regardless of the loading configuration of the wafers.

While this invention has been particularly shown and described with reference to an exemplary embodiment thereof, it will be understood by those skilled in the art that various changes in form and details may be made therein without departing from the spirit and scope of the invention as defined by the appended claims.

What is claimed is:

1. An apparatus for cleaning a wafer, comprising:
a cleaning bath housing adapted to perform a cleaning process;
a loader configured to load the wafer into the cleaning bath housing;
a guide in the cleaning bath housing, configured to support the wafer;
a roller configured to rotatably turn or drive the wafer.

2. The apparatus of claim 1, further comprising one or more solution supply lines configured to supply one or more solutions to the bath.

3. The apparatus of claim 2, further comprising a solution drain line configured to remove the solutions from the bath.

4. The apparatus of claim 1, wherein the loader is configured for either a front-to-back wafer loading configuration or a front-to-front wafer loading configuration.

5. The apparatus of claim 1, wherein the roller is on the loader.

6. The apparatus of claim 1, wherein the guide is configured to support a plurality of wafers at the same time, thus allowing a batch process.

7. A method of cleaning a wafer, comprising the steps of:
loading at least one wafer into a cleaning bath;
rotating the wafer in the bath;
removing impurities from a back surface of the wafer with a cleaning solution; and
rinsing the wafer with a rinsing agent comprising DI water.

8. The method of claim 7, further comprising stopping the rotating step.

9. The method of claim 7, wherein loading the wafer includes loading the wafer on a loader, inserting the wafer on the loader into the bath.

10. The method of claim 9, further comprising supporting the wafer with a guide.

11. The method of claim 7, comprising loading a plurality of wafers into the cleaning bath.

12. The method of claim 9, wherein the loader has either front-to-back wafer loading configuration or front-to-front wafer loading configuration.

13. The method of claim 10, wherein the guide supports the plurality of wafers.

14. The method of claim 7, wherein rotating the wafer comprises circumferentially turning or rotating a roller to drive the wafer.

15. The method of claim 14, wherein the roller rotates a number of wafers in different directions.

16. The method of claim 7, wherein rotating the wafer in the bath comprises turning or rotating a roller in contact with a circumference of the wafer.

17. The method of claim 7, wherein the cleaning solution includes dilute HF.

18. The method of claim 7, further comprising:
treating the wafer with HCl and ozone.

19. The method of claim 18, further comprising:
drying the wafer after treating the wafer.
